(19) United States
(12) Patent Application Publication
(10) Pub. No.: US 2026/0029963 A1
(43) Pub. Date: Jan. 29, 2026

(54) STORAGE DEVICE, DATA PROCESSING METHOD THEREOF AND NON-TRANSITORY COMPUTER READABLE STORAGE MEDIUM

(71) Applicant: Silicon Motion, Inc., Zhubei City (TW)

(72) Inventors: Miao-Hsun WEI, Tainan City (TW); Jhih-Shun YANG, Taipei City (TW)

(73) Assignee: Silicon Motion, Inc., Zhubei City (TW)

(21) Appl. No.: 19/276,450

(22) Filed: Jul. 22, 2025

(30) Foreign Application Priority Data
Jul. 23, 2024 (TW) 113127594

(51) Int. Cl. G06F 3/06

(52) U.S. Cl. CPC G06F 3/0659; G06F 3/0604; G06F 3/0679

(57) ABSTRACT

The present invention discloses a storage device, a data processing method thereof and a non-transitory computer readable storage medium. Whether the storage device is currently operating in a burst mode or a sustain mode is determined. In the burst mode, in response to completion of execution of a command, a host is notified that the command is already completed. In the sustain mode, in response to completion of execution of the command and passing of a delay time, the host is notified that the command is already completed.

This application claims the benefit of Taiwan application Serial No. 113127594, filed Jul. 23, 2024, the subject matter of which is incorporated herein by reference.

### BACKGROUND OF THE INVENTION

### Field of the Invention

The invention relates in general to a storage device, a data processing method thereof and a non-transitory computer readable storage medium.

### Description of the Related Art

Solid-state drive or solid-state disk (SSD) plays an important role in modern technology, and its importance is mainly embodied in the following aspects.

Fast speed: in comparison to conventional mechanical hard disc drive (HDD), SSD does not require mechanical components for reading and writing and therefore produces a faster read/write speed. With this property, the boosting speed of computers becomes faster, the operating speed of application programs is increased, and the processing of a large volume of data is accelerated.

High reliability: SSD dispenses with the use of mechanical components and therefore is more durable than HDD. SSD is less affected by vibrations and collisions and data loss due to mechanical failure is less likely. With this property, SSD has gained a great popularity in application scenarios, such as business servers and data centers, where high reliability is required.

High energy efficiency: SSD does not need to physically move components and therefore consumes less energy than conventional HDD. This indicates that the device using SSD consumes less power and can operate for a longer duration.

Small volume: in comparison to the conventional HDD, SSD has a smaller volume and therefore it is easier to be installed and configured in many situations, particularly notebook computers, tablets, and other small-sized devices.

SSD can be used in wide areas, including but not limited to the following exemplifications. SSD can be used to store the operating system and application programs of a PC to increase system speed and response time. SSD is widely used to store a large volume of data in business servers and data centers, accelerate data processing and operate virtual machines. In the cloud infrastructure, SSD is widely used to provide high-performance virtual machines and fast storage. SSD can be used in the host of a game to accelerate loading during gaming and improve gaming performance. In an embedded system (such as smartphones, tablets, IoT devices), SSD can be used to store and process data.

In general, SSD has become an indispensable device in modern technology. The features of fast speed, high reliability and power saving make SSD valuable in various application scenarios.

In terms of a storage device, quality of service (QoS) is an important index of efficiency and stability, which directly affects user experience. When executing a command, the storage device may have performance jitter and inconsistency due to various causes, such as redundant array of independent disks (RAID), encoding, or garbage collection (GC). These factors may affect the performance of QoS or even lead to serious problems such as command timeout.

Also, the technology for confirming the bandwidth of the storage device without relying on the host or other external tools is currently unavailable.

Therefore, the present application aims to resolve generally-known technical problems disclosed above.

### SUMMARY OF THE INVENTION

According to one embodiment of the present invention, a storage device is provided. The storage device includes a storage device controller, and a storage unit array coupled to the storage device controller, wherein the storage device controller is used to receive a command from a host, and the storage unit array is used to store data. The storage device controller is configured to: determine whether the storage device is currently operating in a burst mode or a sustain mode; in the burst mode, in response to completion of execution of the command, notify the host that the command is already completed; and in the sustain mode, in response to completion of execution of the command and passing of a delay time, notify the host that the command is already completed.

According to another embodiment of the present invention, a data processing method for a storage device is provided. The method includes: determining whether the storage device is currently operating in a burst mode or a sustain mode by a storage device controller; in the burst mode, in response to completion of execution of a command, notifying a host by the storage device controller that the command is already completed; and in the sustain mode, in response to completion of execution of the command and passing of a delay time, notifying the host by the storage device controller that the command is already completed.

According to an alternate embodiment of the present invention, a non-transitory computer readable storage medium is provided. The non-transitory computer readable storage medium records at least one programming command, which performs the following steps after an electronic device is loaded: determining whether a storage device is currently operating in a burst mode or a sustain mode; in the burst mode, in response to completion of execution of a command, notifying a host that the command is already completed; and in the sustain mode, in response to completion of execution of the command and passing of a delay time, notifying the host that the command is already completed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional diagram of a storage device according to an embodiment of the present application.

FIG. 2 is a detailed functional diagram of a storage device according to an embodiment of the present application.

FIG. 3 is a flowchart of a data processing method according to an embodiment of the present application.

FIG. 4 is a flowchart of a downlink data processing method according to an embodiment of the present application.

FIG. 5 is a flowchart of an uplink data processing method according to an embodiment of the present application.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

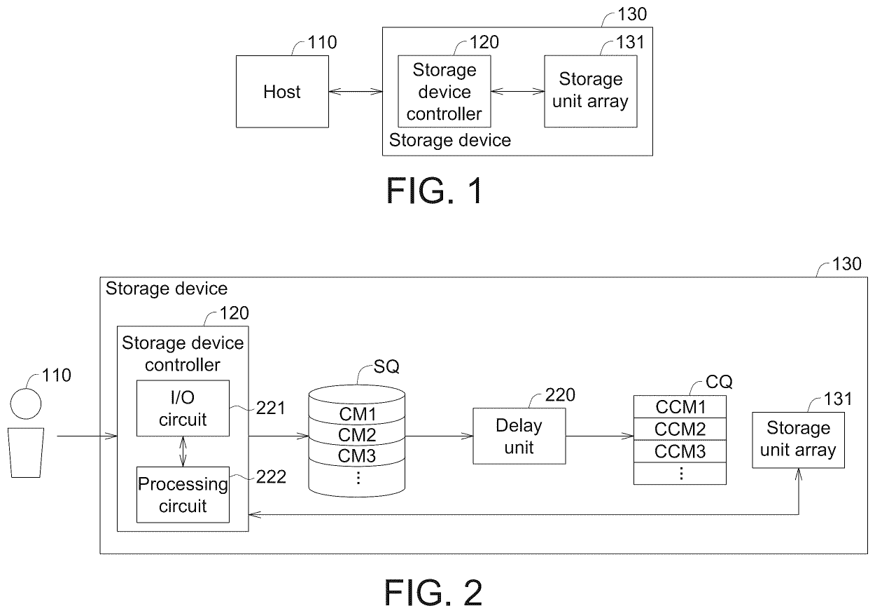

Referring to FIG. 1, a functional diagram of a storage device according to an embodiment of the present application is shown. As indicated in FIG. 1, the storage device 130 (such as an SSD) according to an embodiment of the present application includes a storage device controller 120 and a storage unit array 131. The storage device 130 is coupled to the host 110. The storage device controller 120 is coupled to the storage unit array 131. The storage unit array 131 can be used to store data.

The host 110 can issue a read command or a write command to the storage device controller 120, so that the storage device controller 120 read data from or write data to the storage unit array 131 of the storage device 130 (includes but is not limited to SSD).

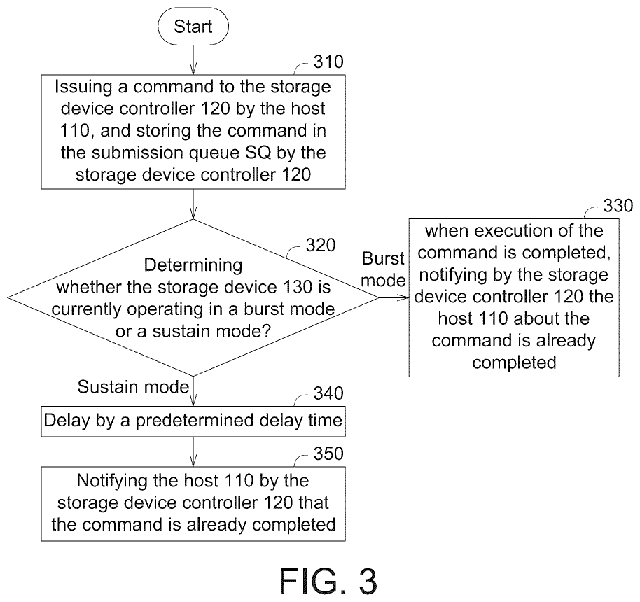

FIG. 2 is a detailed functional diagram of a storage device 130 according to an embodiment of the present application. As indicated in FIG. 2, the storage device controller 120 includes an Input/Output (I/O) circuit 221 and a processing circuit 222. The storage device 130 further includes a submission queue SQ, a delay unit 220, and a completion queue CQ. The storage device controller 120 and the storage device 130 can further include other essential or non-essential components, which are omitted here. The submission queue SQ and the completion queue CQ can be realized by a buffer.

The I/O circuit 221 can be used as an I/O interface between the host 110 and the storage device 130.

The processing circuit 222 is used to control the operations of the storage device controller 120. Detailed descriptions of the function of the processing circuit 222 are disclosed below. The processing circuit 222 can be realized by a chip, a circuit block within a chip, a firmware circuit, or a circuit board containing several electronic components and wires.

The submission queue SQ can be used to temporarily store the tasks or commands that need to be processed. Under normal circumstances, the submission queue SQ is used to receive commands from the host 110 or other equipment, then the received commands are processed in the order of submission.

The storage device controller 120 submits the command (such as a read command or a write command) issued to the submission queue SQ by the host 110. Then, the storage device controller 120 performs processing according to the commands stored in the submission queue SQ, that is, the storage device controller 120 writes data to the storage device 130 or reads data from the storage device 130. The submission queue (SQ) manages and schedules commands or data from the host or other equipment, boosting data processing and transfer efficiency.

When the submitted command is completed, relevant completion information (such as the operating state and the result such as success or failure) will be placed in the completion queue CQ by the storage device controller 120.

The host 110 or other application procedures can periodically check the completion queue CQ to determine whether the submitted command is already completed or not, then perform subsequent processing as necessary. Or, the storage device controller 120 can transfer the completion information to the host 110.

Take FIG. 2 for instance. The commands CM1, CM2, CM3 . . . issued by the host 110 are temporarily stored in the submission queue SQ. When the commands CM1, CM2, CM3 . . . are completed, relevant completion information CCM1, CCM2, CCM3 will be placed in the completion queue CQ, wherein, the completion information CCM1 refers to the completion information of the command CM1, and the rest can be obtained by the same analogy.

When operating in the sustain mode, the delay unit 220 is used to delay the time at which “completion information (such as CCM1 . . . )” is written to the completion queue CQ.

FIG. 3 is a flowchart of a data processing method according to an embodiment of the present application. In step 310, a command is issued to the storage device controller 120 by the host 110, then the command is stored in the submission queue SQ by the storage device controller 120.

In step 320, whether the storage device 130 is currently operating in a burst mode or a sustain mode is determined. In the burst mode, the command will be executed in the absence of any background actions; when the command is completed, the storage device controller 120 will transfer completion information to the host 110. That is, in the burst mode, when the command is completed, the storage device controller 120 notifies the host 110 that the command is already completed. That is, in the burst mode, when the command is completed, the host 110 will obtain the knowledge that the command is already completed.

In the sustain mode, the command is executed in the presence of background action; when the command is completed, the storage device controller 120 will transfer completion information to the host 110 only after a delay time has passed (the delay time can be set by the manufacturer of the storage device controller 120 or the user of the storage device 130). That is, in the sustain mode, when the command is completed, the storage device controller 120 notifies the host 110 that the command is already completed only after the delay time has passed, and only then will the host 110 obtain the knowledge that the command is already completed.

In an embodiment of the present application, how to determine that the storage device is operating in a sustain mode is disclosed below.

In a possible example, when the spare block quantity in the storage unit array 131 is less than a block quantity threshold, the storage device controller 120 may stop processing the command after processing an existing quantity of write commands, then allocate a part of software/hardware resources for the execution of garbage collection (GC) and increase the spare block quantity. Under such circumstances, it can be determined that the storage device controller 120 is currently operating in the sustain mode. On the other hand, when the spare block quantity in the storage unit array 131 is greater than or equivalent to the block quantity threshold, the storage device controller 120 will not execute garbage collection (GC). Meanwhile, it is determined that the storage device controller 120 can utilize most of the hardware/software resources and process commands according to the burst mode. That is, whether the storage device controller 120 is operating in the burst mode or the sustain mode can be determined according to whether the spare block quantity is greater than or equivalent to the block quantity threshold.

In another possible example, during the execution of a read command or a write command, the temperature of the storage device 130 is detected periodically (for instance, the temperature is detected every second). If the temperature is higher than a pre-set temperature threshold (a constant value), command throttling will be activated to bring the temperature down by reducing the efficiency of command processing. Meanwhile, it can be determined that the storage device controller 120 has entered the sustain mode. Conversely, if the detected temperature of the storage device 130 is not higher than the pre-set temperature threshold, command throttling will not be activated. Meanwhile, it can be determined that the storage device controller 120 is operating in the burst mode where the efficiency of command processing is higher. Here, command throttling is implemented by way of periodically idling the storage device controller 120 for some milliseconds (meanwhile, the incoming commands will not be processed) then processing the commands for some other milliseconds. Through command throttling, the processing speed of the commands will be reduced. That is, the burst mode or the sustain mode can be determined according to whether the detected temperature is higher than the pre-set threshold.

When the storage device controller 120 is currently operating in the burst mode, when the command execution is completed, the storage device controller 120 notifies the host 110 that the command is already completed (that is, the storage device controller 120 places the completion information of the command in the completion queue CQ), as indicated in step 330.

When the storage device controller 120 is currently operating in the sustain mode, when the command execution is completed, the storage device controller 120 notifies the host 110 that the command is already completed only after a delay time has passed. That is, only after the delay time (executed by the delay unit 220) (such as step 340), will the storage device controller 120 notify the host 110 that the command is already completed (such as step 350), so that the possibility of command timeout will be reduced.

In an embodiment of the present application, relevant completion information of these commands completed earlier are written to the completion queue CQ only after a delay time has passed, so that the host 110 will not quickly issue the next command. This is because once the host 110 issues a command, the host 110 immediately starts time counting. When the storage device controller 120 is in sustain mode, in case that it fails to complete the command in time, a command timeout may be occurred. In an embodiment of the present application, the above delay mechanism avoids the timer of the host 110 starting time counting too early, so that these commands completed later can have more time to prepare, and the possibility of command timeout can be reduced.

In an embodiment of the present application, how to evaluate the bandwidth of the storage device 130 (that is, its own performance) without relying on the host or any external tools is disclosed below.

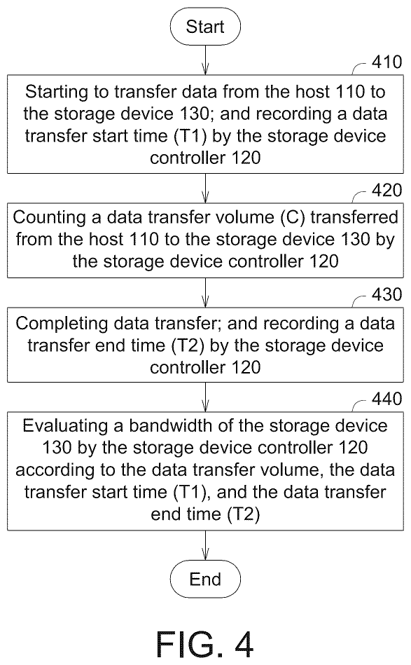

FIG. 4 is a flowchart of a downlink data processing method according to an embodiment of the present application. Here, “downlink” refers to data being transferred from the host 110 (data source) to the storage device 130 (data destination). The method as indicated in FIG. 4 is executed by the storage device controller 120.

In step 410, data starts to be transferred from the host 110 to the storage device 130; a data transfer start time (T1) is recorded by the storage device controller 120.

In step 420, a data transfer volume (C) transferred from the host 110 to the storage device 130 is counted by the storage device controller 120.

In step 430, data transfer is completed; a data transfer end time (T2) is recorded by the storage device controller 120.

In step 440, a bandwidth of the storage device 130 (that is, its own performance) is evaluated by the storage device controller 120 according to the data transfer volume, the data transfer start time (T1), and the data transfer end time (T2). For instance, the bandwidth estimation value=C/(T2−T1), wherein, C represents data transfer volume.

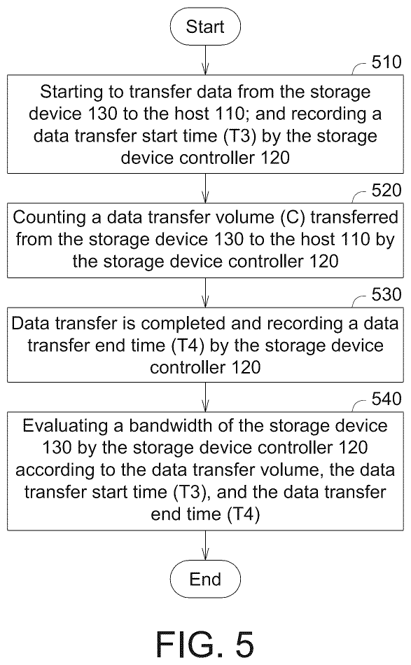

FIG. 5 is a flowchart of an uplink data processing method according to an embodiment of the present application. Here, “uplink” refers to data being transferred from the storage device 130 to the host 110. The method as indicated in FIG. 5 is executed by the storage device controller 120.

In step 510, data starts to be transferred from the storage device 130 (data source) to the host 110 (data destination); a data transfer start time (T3) is recorded by the storage device controller 120.

In step 520, a data transfer volume (C) transferred from the storage device 130 to the host 110 is counted by the storage device controller 120.

In step 530, data transfer is terminated; a data transfer end time (T4) is recorded by the storage device controller 120.

In step 540, a bandwidth of the storage device 130 (that is, its own performance) is evaluated by the storage device controller 120 according to the data transfer volume, the data transfer start time (T3), and the data transfer end time (T4). For instance, the bandwidth estimation value=C/(T4−T3), wherein, C represents data transfer volume.

For instance, if the bandwidth estimation value is too low, the bandwidth of the storage device 130 (that is, its own performance) can be improved through alternate technical methods.

Besides, FIG. 4 and FIG. 5 also can determine whether the storage device is currently operating in a burst mode or a sustain mode. In an illustrative rather than a restrictive sense, when the bandwidth estimation value is higher than a bandwidth threshold, it is determined that the storage device is currently operating in the burst mode. When the bandwidth estimation value is equivalent to or lower than the bandwidth threshold, it is determined that the storage device is currently operating in the sustain mode.

According to the embodiments of the present application, in the sustain mode, command timeout can be avoided if the host is notified of the completion of the command execution only after a delay time has passed.

According to the embodiments of the present application, the storage device controller 120 can evaluate the bandwidth of the storage device 130 (that is, its own performance) without relying on the host or any external tools.

Although many specific details are described in the present application, these specific details should not be interpreted as restrictions of the scope of protection of the claims; rather, they should be regarded as descriptions of the features of specific implementations. In the application, a sub-combination of some features described in the context of a single embodiment can be implemented in one single embodiment. Conversely, various features described in the context of one single embodiment can be implemented in one or a suitable sub-combination of several embodiments. Initially, the descriptions may suggest that some features would function only when they are included in some combinations, and such combinations may even be specified. However, under some circumstances, one or some features can be deleted from the said combinations, which are related to one specific sub-combination or variations thereof. Similarly, although the operations of the method are illustrated in a specific order, it does not mean that these operations must be executed according to the illustrated order or that all illustrated operations must be executed in order to achieve desired results.

Although only some examples and implementations are disclosed in the above embodiments of the application, based on the disclosed contents, modifications, adjustments, and improvements.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A storage device, comprising:
a storage device controller used to receive a command from a host, and
a storage unit array coupled to the storage device controller to store data,
wherein, the storage device controller is configured to:
determine whether the storage device is currently operating in a burst mode or a sustain mode;
in the burst mode, in response to completion of execution of the command, notify the host that the command is already completed; and
in the sustain mode, in response to completion of execution of the command and passing of a delay time, notify the host that the command is already completed.

2. The storage device according to claim 1, wherein, the storage device controller determines whether the storage device is currently operating in the burst mode or the sustain mode according to whether a spare block quantity is greater than or equal to a block quantity threshold.

3. The storage device according to claim 2, wherein,
when the spare block quantity is less than the block quantity threshold, the storage device controller determines that the storage device is currently operating in the sustain mode; and
when the spare block quantity is not less than the block quantity threshold, the storage device controller determines that the storage device is currently operating in the burst mode.

4. The storage device according to claim 1, wherein, the storage device controller determines whether the storage device is currently operating in the burst mode or the sustain mode according to whether a detected temperature of the storage device is higher than a temperature threshold.

5. The storage device according to claim 4, wherein,
when the detected temperature of the storage device is higher than the temperature threshold, the storage device controller determines that the storage device is currently operating in the sustain mode; and
when the detected temperature of the storage device is not higher than the temperature threshold, the storage device controller determines that the storage device is currently operating in the burst mode.

6. The storage device according to claim 1, wherein,
when a bandwidth estimation value is higher than a bandwidth threshold, the storage device controller determines that the storage device is currently operating in the burst mode; and
when the bandwidth estimation value is not higher than the bandwidth threshold, the storage device controller determines that the storage device is currently operating in the sustain mode.

7. The storage device according to claim 6, wherein:
the bandwidth estimation value is calculated according to a data transfer start time, a data transfer end time, and a data volume transferred between the data transfer start time and the data transfer end time.

8. A data processing method for a storage device, comprising:
determining whether the storage device is currently operating in a burst mode or a sustain mode by a storage device controller;
in the burst mode, when execution of a command is completed, notifying a host by the storage device controller that the command is already completed; and
in the sustain mode, in response to completion of execution of the command and passing of a delay time, notifying the host by the storage device controller that the command is already completed.

9. The data processing method for a storage device according to claim 8, wherein, the storage device controller determines whether the storage device is currently operating in the burst mode or the sustain mode according to whether a spare block quantity is greater than or equal to a block quantity threshold.

10. The data processing method for a storage device according to claim 9,
wherein,
when the spare block quantity is less than the block quantity threshold, the storage device controller determines that the storage device is currently operating in the sustain mode; and
when the spare block quantity is not less than the block quantity threshold, the storage device controller determines that the storage device is currently operating in the burst mode.

11. The data processing method for a storage device according to claim 8, wherein, the storage device controller determines whether the storage device is currently operating in the burst mode or the sustain mode according to whether a detected temperature of the storage device is higher than a temperature threshold.

12. The data processing method for a storage device according to claim 11,
wherein,
when the detected temperature of the storage device is higher than the temperature threshold, the storage device controller determines that the storage device is currently operating in the sustain mode; and
when the detected temperature of the storage device is not higher than the temperature threshold, the storage device controller determines that the storage device is currently operating in the burst mode.

13. The data processing method for a storage device according to claim 8,
wherein,
when a bandwidth estimation value is higher than a bandwidth threshold, the storage device controller determines that the storage device is currently operating in the burst mode; and
when the bandwidth estimation value is not higher than the bandwidth threshold, the storage device controller determines that the storage device is currently operating in the sustain mode.

14. The data processing method for a storage device according to claim 13,
wherein,
the storage device controller calculates the bandwidth estimation value according to a data transfer start time, a data transfer end time, and a data volume transferred between the data transfer start time and the data transfer end time.

15. A non-transitory computer readable storage medium recording at least one programming command and performing the following steps after loaded by an electronic device:
determining whether a storage device is currently operating in a burst mode or a sustain mode;
in the burst mode, when execution of a command is completed, notifying a host that the command is already completed; and
in the sustain mode, in response to completion of execution of the command and passing of a delay time, notifying the host that the command is already completed.

16. The non-transitory computer readable storage medium according to claim 15, wherein,
whether the storage device is currently operating in the burst mode or the sustain mode is determined according to whether a spare block quantity is greater than or equal to a block quantity threshold; or
whether the storage device is currently operating in the burst mode or the sustain mode is determined according to whether a detected temperature of the storage device is higher than a temperature threshold; or
whether the storage device is currently operating in the burst mode or the sustain mode is determined according to whether a bandwidth estimation value is higher than a bandwidth threshold.

17. The non-transitory computer readable storage medium according to claim 16, wherein,
when the spare block quantity is less than the block quantity threshold, it is determined that the storage device is currently operating in the sustain mode; and
when the spare block quantity is not less than the block quantity threshold, it is determined that the storage device is currently operating in the burst mode.

18. The non-transitory computer readable storage medium according to claim 16, wherein,
when the detected temperature of the storage device is higher than the temperature threshold, it is determined that the storage device is currently operating in the sustain mode; and
when the detected temperature of the storage device is not higher than the temperature threshold, it is determined that the storage device is currently operating in the burst mode.

19. The non-transitory computer readable storage medium according to claim 16, wherein,
when the bandwidth estimation value is higher than the bandwidth threshold, it is determined that the storage device is currently operating in the burst mode; and
when the bandwidth estimation value is not higher than the bandwidth threshold, it is determined that the storage device is currently operating in the sustain mode.

20. The non-transitory computer readable storage medium according to claim 19, wherein,
the bandwidth estimation value is calculated according to a data transfer start time, a data transfer end time, and a data volume transferred between the data transfer start time and the data transfer end time.
